(19) United States
(12) Patent Application Publication
(10) Pub. No.: US 2009/0025750 A1
(43) Pub. Date: Jan. 29, 2009

(54) Method for removal of a deposition from an optical element, lithographic apparatus, and method for manufacturing a device

(75) Inventors: Maarten Marinus Wilhelmus Van Herpen, Heesch (NL); Antonius Theodorus Kempen, GL's-Hertogenbosch (NL); Wouter Anthon Soer, Nijmegen (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 11/878,436

(22) Filed: Jul. 24, 2007

(51) Int. Cl. B08B 5/00; B08B 6/00; G03B 21/26

(52) U.S. Cl. 134/1.1; 134/31; 134/99.1; 353/28

(57) ABSTRACT

A method of removing a deposition from an optical element of an apparatus. The method includes providing a hydrogen comprising gas in at least a part of the apparatus, providing nitrogen radicals in the part of the apparatus for generating hydrogen radicals from the hydrogen comprising gas, and contacting the optical element with at least part of the hydrogen radicals to removal the deposition.

### FIELD

The invention relates to a method for a removal of a deposition on an optical element, an apparatus, a lithographic apparatus, and a method of manufacturing a device.

### BACKGROUND

Lithographic apparatus as known in the art comprises a radiation system constructed to provide a projection beam of radiation. Usually, a source of ultra-violet radiation is used. Such source may be arranged to generate the radiation beam with a wavelength of about 193 nm, or of about 157 nm. Alternatively, the radiation source may be arranged to generate Extreme Ultra Violet (EUV) radiation having a wavelength of below about 50 nm (usually 13.5 nm). An illumination system comprising a plurality of suitably arranged optical elements may be constructed to condition the radiation beam, for example to focus the radiation beam at an intermediate focus position. Lithographic apparatus can be used, for example, in the manufacture of integrated circuits (IC). In such a case, the radiation beam is patterned using a suitable patterning device and is subsequently projected on a suitable patternable substrate. The patternable substrate is preferably arranged on a substrate table, which may be constructed to hold the substrate and to displace it, if desired.

The “patterning device” may refer to a device that can be used to endow an incoming radiation beam with a patterned cross-section, corresponding to a pattern that is to be created in a target portion of the substrate. Generally, the pattern will correspond to a particular functional layer in a device being created in the target portion, such as integrated circuit or other device. An example of a patterning device is a mask. The concept of a mask is well known in lithography, and it includes mask types such as binary, alternating phase-shift, attenuated phase shift, as well as various hybrid mask types. Placement of such a mask in the radiation beam causes elective transmission (in the case of a transmissible mask) or reflection (in the case of a reflective mask) of the radiation impinging on the mask, according to the pattern of the mask. The mask is usually supported by a support structure, like a mask table, which ensures that the mask can be held at a desired position in the incoming radiation beam, and that it can be moved relative to the beam if so desired.

Another example of a patterning device is a programmable mirror array. One example of such an array is a matrix-addressable surface, for example having viscoelastic control layer and a reflective surface. The basic principle behind functioning of such mirror array is that, for example, addressed areas of the reflective surface reflect incident light as diffracted light, whereas unaddressed areas reflect incident light as undiffracted light. Using an appropriate filter, the undiffracted light may be filtered out of the reflected beam, leaving only the diffracted light behind. In this manner, the beam becomes patterned according to the addressing pattern of the matrix-addressable surface. An alternative embodiment of a programmable mirror array employs a matrix arrangement of tiny mirrors, each of which can be individually tilted about an axis by applying a suitable localized electric field, or by employing piezoelectric actuators. Once again, the mirrors are matrix-addressable, such that addressed mirrors will reflect an incoming radiation beam in a different direction with respect to unaddressed mirrors. The matrix addressing can be performed using suitable electronics. In both of the situations described hereinabove, the patterning device can comprise one or more programmable mirror arrays. For the programmable mirror array a corresponding support structure may be embodied as a frame or table, for example, which may be fixed or movable as required.

Another example of patterning device is a programmed LCD array. An example is given in U.S. Pat. No. 5,229,872. Also for such patterning device a support structure may be embodied as a frame or table, for example, which may be fixed or movable as desired.

The lithographic apparatus further comprises a projection system arranged with a suitable plurality of further optical elements configured to project the patterned radiation beam onto the target portion of the substrate. The projection system is often referred to as a ”lens”. However, this term may be broadly interpreted as encompassing various types of projection systems, including refractive optics, reflective optics and catadioptric systems, for example.

Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction.

It is acknowledged that in a lithographic apparatus radiation-induced deposition of carbon contamination may occur, causing formation of parasitic films on optical elements, for example hydrocarbon or carbon films, which may decrease the quality of a lithographic process. Even very thin carbon films can absorb a remarkable amount of the projection beam, leading to a reduction in energy throughput in the optical train. This particularly holds to the EUV radiation beam. Further, these carbon films may be non-homogeneous and as such can result in phase shifts and patterning errors. Therefore, it is desirable to mitigate the effects of carbon contamination.

An embodiment of an arrangement for removing carbon deposition is published in United States Patent Application Publication No. 2004/0105084. The arrangement is constructed to provide a composition comprising one or more perhalogenated C1-C6 alkanes and one or more compounds consisting of one or more nitrogen atoms and hydrogen atoms in an atmosphere of the lithographic apparatus. The composition and the compounds are conceived to be activated, notably leading to excitation and dissociation of the molecules of the compound into reactive species. The source of the compound is arranged in fluid communication with an atmosphere of the lithographic apparatus, the compound being supplied in gaseous form or as a beam of molecules.

It may be a disadvantage of the above mentioned arrangement that activation of the compound occurs in a not specific area of the lithographic apparatus, which may lead to a reduced efficiency of the cleaning action of suitable activated species. For example, a free path of hydrogen radicals, which may be formed by dissociation of hydrogen molecules is relatively short. In particular, three-body recombination and surface recombination rate may not allow hydrogen radicals formed in the atmosphere of the known lithographic apparatus to reach target areas, like a mirror, a reticle, a grating, nested shells of particular optical elements, e.g. multilayers, or the like leading to substantial accumulation of contamination layers at some areas.

### SUMMARY

It is desirable to provide a lithographic apparatus in which removal of deposition, for example removal of hydrocarbon and/or Sn deposition, is improved.

According to an aspect of the invention, there is provided a method for removing a deposition from an optical element of an apparatus is provided. The method includes providing a hydrogen comprising gas in at least a part of the apparatus, providing nitrogen radicals in the part of the apparatus for generating hydrogen radicals from the hydrogen comprising gas, and contacting the optical element with at least part of the hydrogen radicals to removal the deposition.

According to an aspect of the invention, there is provided an apparatus that includes an optical element, a first inlet configured to provide hydrogen comprising gas in at least part of the apparatus, and a second inlet configured to provide nitrogen radicals in the part of the apparatus to generate hydrogen radicals from the hydrogen comprising gas.

According to an aspect of the invention, there is provided a lithographic apparatus that includes an illumination system comprising a first optical element constructed to condition a radiation beam, and a support constructed to support a patterning device. The patterning device is configured to impart the radiation beam with a pattern in its cross-section to form a patterned radiation beam. The apparatus also includes a substrate table constructed to hold a substrate, a projection system comprising a second optical element configured to project the patterned radiation beam onto a target portion of the substrate, a hydrogen comprising gas, and a source of nitrogen radicals arranged to generate hydrogen radicals from the hydrogen comprising gas to remove a deposition from at least a surface of the first optical element and/or the second optical element.

According to an aspect of the invention, there is provided a device manufacturing method that includes projecting a patterned beam of radiation onto a substrate using a lithographic apparatus, and providing nitrogen radicals in an atmosphere of the lithographic apparatus for interacting with a hydrogen comprising gas present in said atmosphere for generating hydrogen radicals for removing a deposition from a surface of an optical element of the lithographic apparatus.

### BRIEF DESCRIPTION OF THE DRAWINGS

Embodiments of the invention will now be described, by way of example only, with reference to the accompanying schematic drawings in which corresponding reference symbols indicate corresponding parts, in which:

FIG. 1 presents a schematic view of an embodiment of a lithographic apparatus according to the invention.

FIG. 2 presents a schematic view of an embodiment of a portion of a lithographic apparatus according to the invention.

### DETAILED DESCRIPTION

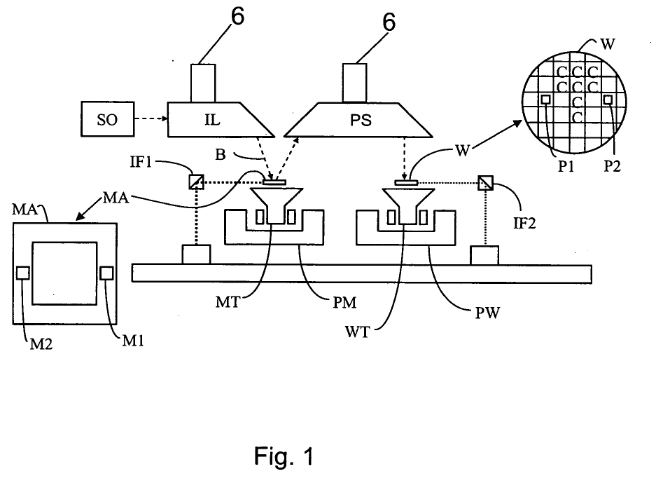

FIG. 1 schematically depicts a lithographic apparatus according to one embodiment of the invention. The apparatus comprises: an illumination system (illuminator) IL configured to condition a radiation beam B (e.g. UV radiation or EUV radiation). An embodiment of the present invention is directed to low wavelength lithography systems such as those operating at 193 nm and 157 nm as well as extreme ultraviolet lithography tools. Typically, EUV systems operate using a wavelength of below about 50 nm, preferably below about 20 nm, and most preferably below about 15 nm. An example of a wavelength in the EUV region which is gaining considerable interest in the lithography industry is 13.4 nm, though there are also other promising wavelengths in this region, such as 11 nm, for example. The apparatus also comprises a support structure (e.g. a mask table) MT constructed to support a patterning device (e.g. a mask) MA and connected to a first positioner PM configured to accurately position the patterning device in accordance with certain parameters; a substrate table (e.g. a wafer table) WT constructed to hold a substrate (e.g. a resist-coated wafer) W and connected to a second positioner PW configured to accurately position the substrate in accordance with certain parameters; and a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e. bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a reflective type (e.g. employing a reflective mask). Alternatively, the apparatus may be of a transmissive type (e.g. employing a transmissive mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system comprising, for example, suitable directing mirrors and/or a beam expander. In other cases the source may be an integral part of the lithographic apparatus, for example when the source is a mercury lamp. The source SO and the illuminator IL, together with the beam delivery system if required, may be referred to as a radiation system.

The illuminator IL may comprise an adjuster for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator and a condenser. The illuminator may be used to condition the radiation beam, to have a desired uniformity and intensity distribution in its cross-section.

The radiation beam B is incident on the patterning device (e.g., mask MA), which is held on the support structure (e.g., mask table MT), and is patterned by the patterning device. Having traversed the mask MA, the radiation beam B passes through the projection system PS, which focuses the beam onto a target portion C of the substrate W. With the aid of the second positioner PW and position sensor IF2 (e.g. an interferometric device, linear encoder or capacitive sensor), the substrate table WT can be moved accurately, e.g. so as to position different target portions C in the path of the radiation beam B. Similarly, the first positioner PM and another position sensor IF1 can be used to accurately position the mask MA with respect to the path of the radiation beam B, e.g. after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

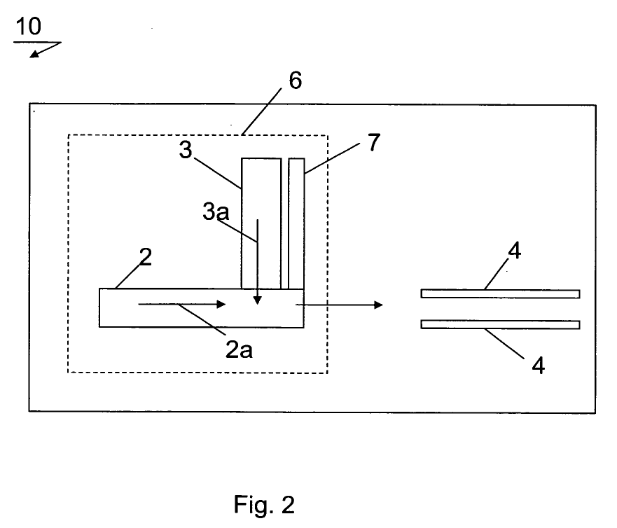

In accordance with an aspect of the invention the lithographic apparatus is provided with a module 6 comprising a source of nitrogen radicals arranged to provide said nitrogen radicals in at least a part of the lithographic apparatus for generating hydrogen radicals from a hydrogen comprising gas present in the lithographic apparatus. It should be understood that the term hydrogen comprising gas may refer to a gas comprising a molecule with a hydrogen atom. The thus formed hydrogen radicals are conceived to remove depositions from at least a surface of an optical element of the lithographic apparatus. The optical element may relate to a mirror, a grating, a reticle, or a sensor. The operation of the module 6 will be described in more detail with reference to FIG. 2.

In accordance with this aspect of the invention an effective method of removal of depositions from an optical element is provided. The deposition conceived to be thus removed may comprise one or more elements selected from a group of B, C, Si, Ge and Sn. There is a fundamental difference between a surface recombination rate of hydrogen radicals and a surface recombination rate of nitrogen radicals. Table 1 shows an abstract of a comparison between characteristic surface recombination coefficients for nitrogen radicals (γ_{N}) and hydrogen (γ_{H}) radicals, as found in the literature.

TABLE 1

| Surface | | | |
|---|---|---|---|
| material | (γ_{N}) | (γ_{H}) | Reference |
| Mo on glass | 0.06 at 0.1 Torr | | [1] |
| | 0.03 at 0.5 Torr | | |
| | 0.011 at 1 Torr | | |
| | Extrapolated: | | |
| | 3.5 × 10⁻³ at 10 Torr | | |
| | 3.5 × 10⁻³ at 100 Torr | | |
| Cu oxide | 8 × 10⁻³ at 3 Torr | | [2] |
| Cu | | 0.1 | [3] |
| Ag oxide | 5.2 × 10⁻³ at 3 Torr | | [2] |
| Pyrex/Quartz | 10⁻⁷ to 10⁻³ | 3.4 × 10⁻³ | [1], [4], [5] |
| Pd | | 0.08 | [3] |
| Ni | | 0.2 | [3] |
| Ti | | 0.4 | [3] |

wherein:
[1]: G. N. Hays et al, “Surface catalytic efficiency of a sputtered molybdenum layer on quartz and pyrex for the recombination of nitrogen atoms”, J. Chem. Phys. 60, 2027-2034 (1973);
[2]: R. A. Young, “Measurements of the diffusion coefficient of atomic nitrogen in molecular nitrogen and the catalytic efficiency of silver and copper oxide surfaces”, J. Chem. Phys. 34, 1295-1301 (1961);
[3]: B. J. Wood, H. Wise, “Kinetics of hydrogen atom recombination on surfaces”, J. Phys. Chem. 65, 1976-1983 (1961);
[4]: W. V. Smith, “The surface recombination of H atoms and OH radicals”, J. Chem. Phys. 11, 110-125 (1943);
[5]: H. Wise and B. J. Wood, “Reactive collisions between gas and surface atoms”, Adv. At. Mol. Phys. 3, 291-353 (1967).

A pressure dependence of a surface recombination coefficient is given by an equation:

γ(p)=A[exp(−Cp)+q],

wherein
p is a pressure;
A, C are constants dependent on the type of surface material and temperature;
q is a constant accounting for a probability of surface recombination.

Due to roughness of a surface and a probable disorder of a surface shielding by molecules, a fraction of the gas atoms will reach the surface even for very high pressures. Usually q is substantially less than unity. It is found that for a substantially low surface roughness, corresponding, for example, to a surface condition of optical elements used for EUV lithography, the value of constant q will be substantially equal to zero.

It has been found that for the EUV lithography, a surface recombination coefficient for nitrogen radicals substantially reduces for pressures above 10 mbar. This means that the nitrogen radical has a substantially increased lifetime leading to an elongated cleaning range in an atmosphere of an apparatus, compared to the cleaning range of hydrogen radicals. For example, while a cleaning range of about 10 cm for hydrogen radicals can in practice be reached using a high velocity gas flow and pressures of 100 mbar and higher, the cleaning range of about 10 cm for nitrogen radicals can be reached substantially for any pressure in the range of 0.01 mbar up to about 1000 mbar. Actually, substantially all pressures applicable to a lithographic apparatus may be used. Therefore, when the nitrogen radicals are provided in an atmosphere of an apparatus conceived to be cleaned, the nitrogen radicals substantially reach surfaces conceived to be cleaned and generate hydrogen radicals substantially in a direct vicinity of said surfaces. This substantially improves the cleaning efficiency. In an embodiment, a source of hydrogen may be provided. The source of hydrogen may be a source of hydrogen molecules and may be arranged in a vicinity of the source of nitrogen radicals. The source of hydrogen molecules may be integrated with the source of the nitrogen radicals, thereby yielding a hybrid source. The hybrid source may be advantageously positioned in a vicinity of an optical element conceived to be cleaned, for example in a vicinity of an illumination system of a lithographic apparatus. It has been found that thus formed hydrogen radicals effectively remove deposited hydrocarbon layers on optical elements, as well as effectively remove particle contamination, for example Sn contamination, caused by a plasma source. Alternatively or additionally, the hydrogen source and the nitrogen radicals generator may be arranged in a vicinity of the projection system to clean targeted optical elements, for example mirrors, of the projection system. Other optical elements conceived to be cleaned comprise reticle, LCD arrays or mirror arrays of a spatial light modulator, or sensors. In the latter embodiment, the thus formed hydrogen radicals are mainly used to remove carbon and carbon associated contamination, like formation of hydrocarbon films on the optical elements of the projection system.

FIG. 2 presents in a schematic way an embodiment of a portion 10 of a lithographic apparatus as is set forth in the foregoing. The portion 10 may be related to the illumination system and/or to the projection system of the lithographic apparatus, or the portion 10 may relate to an optical system of another suitable apparatus, for example an EUV microscope. This particular embodiment relates to an embodiment, in which the source of hydrogen 3 is provided, and the source cooperates with the source of nitrogen radicals 2. A source of hydrogen molecules may be integrated with the source of nitrogen radicals in the module 6. Such source may be referred to as a hybrid source. The source of nitrogen radicals may comprise a discharge source, such as a radiofrequency discharge source. More preferably, a gas outlet 3a of the source of hydrogen molecules 3 is arranged in a direct vicinity of a gas outlet 2a of the source of nitrogen radicals 2. Preferably, in the hybrid source, the inlet of hydrogen molecules and the inlet of the nitrogen molecules are adjacently arranged or merged so that both H2 molecules and N2 molecules may be dissociated by action of a radiofrequency source. An optical element 4 conceived or targeted to be cleaned is schematically illustrated in FIG. 2. For example, the optical element may relate to a multilayer mirror having a plurality of surfaces.

Possible chemical reactions for producing hydrogen atoms with nitrogen atoms radicals comprise:

N+H2→NH2, followed by

NH2+H2→H

It is noted that other molecules than H2 may be radicalized yielding hydrogen radicals.

Further chemical reactions for producing hydrogen radicals comprise:

N(g)+2 H2(g)→NH3(g)+H(g)

NH(g)+1.5 H2(g)→NH3(g)+H(g)

NH2(g)+H2(g)→NH3(g)+H(g)

N(g)+1.5 H2(g)→NH2(g)+H(g).

It is found that by providing the source of the hydrogen molecules in direct vicinity of a nitrogen radicals generator, a controlled generation of hydrogen radicals is achieved. A flux of hydrogen radicals may be selected at the optical surface between at least 1×10¹⁴/cm² and 1×10¹⁶/cm², more preferably at about 1×10¹⁵/cm². The nitrogen flux at the optical surface is preferably set between at least 1×10¹⁴/cm² and 1×10¹⁶/cm², more preferably at about 1×10¹⁵/cm².

In addition, it is found to be advantageous to employ a substantially elevated hydrogen and/or nitrogen gas flow along a trajectory between respective gas sources or a hybrid source and an optical element conceived to be cleaned. Good results have been obtained for respective gas flows being selected in a range of about 60%-99% of the sound velocity in the atmosphere of the apparatus, preferably in a range of about 80%-99% of the sound velocity, more preferably more than about 90% of the sound velocity. For example, for a life time of hydrogen radicals of about 10 ms, the free path of about 10 cm is obtainable with said flow velocities.

At least the source of nitrogen radicals may be arranged in a direct vicinity of the surface conceived to be cleaned, which allows the hydrogen radicals to be formed at specific positions in the lithographic apparatus. Due to the fact that a mean free path of hydrogen radicals is relatively short, generation of hydrogen radicals in a vicinity of a target surface of an optical element may increase cleaning efficiency. An example of the optical element, for example a Mo/Si multi-layer mirror comprises a Ru surface, notably a Ru cap layer. An embodiment of the Ru cap layer is known from United States Patent Application Publication No. 2006/0072084.

In an embodiment, a relatively small amount of hydrogen comprising methane may be added to the atmosphere in which hydrogen radicals are formed. This may be enabled by an addition of a suitable source of methane 7. It has been found that an addition of about 5% of methane substantially increases the cleaning rate. From the Ru surface, the cleaning rate increases with several orders of magnitude, allowing, for example, 0.6 nm Sn foil to be removed within a time period of less than one hour.

In an embodiment, the surface may be coated with a Si₃N₄ coating. Such coating may have a function of a cleaning cap layer that both improves a cleaning rate and protects Ru surface from aggressive reactants (hydrogen radicals). It has been found that when a 5 nm of Si₃N₄ was deposited on a Ru surface, the cleaning rate was similar to a cleaning rate from a silicon surface (>700 nm/hour), which provides a substantial improvement. In particular, it has been found that an addition of such cleaning cap layer leads to a substantially complete cleaning of a collector mirror forming part of the illumination system of the lithographic apparatus. In particular, good results have been obtained for a grazing incidence collector used in the illumination system. The grazing incidence collector comprises a grazing incidence mirror onto which radiation is directed at an angle smaller than about 20 degrees. Such grazing incidence mirrors may be manufactured from a multilayer, or from a single metal layer. It has been further demonstrated that the thus formed hydrogen radicals provide effective means to remove Sn and/or C contamination, such as Sn particles and/or hydrocarbons. It is also noted that nitrogen atoms may also contribute to the elevated efficiency of removal of named depositions on an optical element of an apparatus, for example of a lithographic apparatus.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

What is claimed is:

1. A method of removing a deposition from an optical element of an apparatus, the method comprising:
providing a hydrogen comprising gas in at least a part of the apparatus;
providing nitrogen radicals in said part of the apparatus for generating hydrogen radicals from the hydrogen comprising gas; and
contacting the optical element with at least part of the hydrogen radicals to removal said deposition.

2. A method according to claim 1, wherein the deposition comprises one or more elements selected from a group of B, C, Si, Ge and Sn.

3. A method according to claim 1, wherein the nitrogen radicals are generated from a nitrogen comprising gas by a filament, a plasma or a radiation.

4. A method according to claim 1, wherein the hydrogen comprising gas is provided from a source of hydrogen molecules.

5. A method according to claim 4, wherein the source of hydrogen molecules is integrated with a source of nitrogen radicals yielding a hybrid source for providing nitrogen radicals and hydrogen radicals in at least said part of the apparatus.

6. A method according to claim 5, wherein the hybrid source is arranged in a vicinity of the optical element.

7. A method according to claim 1, wherein the apparatus comprises a lithographic apparatus.

8. A method according to claim 7, wherein the optical element is selected from the group consisting of a mirror, a grating, a reticle, and a sensor.

9. A method according to claim 8, wherein the optical element forms part of a grazing incidence collector module.

10. A method according to claim 1, further comprising generating a flow of at least a nitrogen radical containing gas in the atmosphere of the apparatus in a range of about 60-99% of the sound velocity associated with said atmosphere.

11. A method according to claim 1, further comprising providing methane in at least a part of the apparatus.

12. An apparatus comprising:
an optical element;
a first inlet configured to provide hydrogen comprising gas in at least part of the apparatus; and
a second inlet configured to provide nitrogen radicals in said part of the apparatus to generate hydrogen radicals from the hydrogen comprising gas.

13. An apparatus according to claim 12, wherein the second inlet forms part of a source of nitrogen radicals, said source being selected from the group consisting of a filament, a plasma, and a radiation.

14. An apparatus according to claim 12, wherein the first inlet forms part of a source of hydrogen molecules, said source being integrated with the source of nitrogen radicals.

15. An apparatus according to claim 14, wherein the apparatus comprises a lithographic apparatus.

16. An apparatus according to claim 12, wherein the optical element is selected from the group consisting of a mirror, a grating, a reticle, and a sensor.

17. An apparatus according to claim 12, wherein at least the source of nitrogen radicals is arranged to generate a flow a nitrogen gas in the atmosphere of the apparatus in a range of about 60%-99% of the sound velocity associated with said atmosphere.

18. A lithographic apparatus comprising:
an illumination system comprising a first optical element constructed to condition a radiation beam;
a support constructed to support a patterning device, the patterning device being configured to impart the radiation beam with a pattern in its cross-section to form a patterned radiation beam;
a substrate table constructed to hold a substrate;
a projection system comprising a second optical element configured to project the patterned radiation beam onto a target portion of the substrate;
a hydrogen comprising gas; and
a source of nitrogen radicals arranged to generate hydrogen radicals from the hydrogen comprising gas to remove a deposition from at least a surface of the first optical element and/or the second optical element.

19. A lithographic apparatus according to claim 18, wherein the source of nitrogen radicals is selected from the group consisting of a filament, a plasma, and a radiation.

20. A lithographic apparatus according to claim 18, further comprising a source of a hydrogen comprising gas, said source being integrated with the source of nitrogen radicals.

21. A lithographic apparatus according to claim 20, wherein a gas outlet of the source of hydrogen comprising gas is arranged in a direct vicinity of a gas outlet of the source of nitrogen radicals.

22. A lithographic apparatus according to claim 18, wherein at least the source of nitrogen radicals is arranged in a direct vicinity of the surface to be cleaned.

23. A lithographic apparatus according to claim 18, wherein the first optical element and/or the second optical element are selected from the group consisting of a mirror, a grating, a reticle, and a sensor.

24. A lithographic apparatus according to claim 18, wherein the optical element comprises a Ru surface.

25. A lithographic apparatus according to claim 18, further comprising a source of methane.

26. A lithographic apparatus according to claim 18, wherein the surface is provided with a Si₃N₄ coating.

27. A lithographic apparatus according to claim 18, wherein the deposition comprises one or more elements selected from the group consisting of B, C, Si, Ge, and Sn.

28. A lithographic apparatus according to claim 18, wherein the illumination system comprises a grazing incidence collector.

29. A lithographic apparatus according to claim 18, wherein at least the source of nitrogen radicals is arranged to generate a flow a nitrogen gas in the atmosphere of the apparatus in a range of about 0.60-0.99 of the sound velocity associated with said atmosphere.

30. A device manufacturing method comprising:
projecting a patterned beam of radiation onto a substrate using a lithographic apparatus; and
providing nitrogen radicals in an atmosphere of the lithographic apparatus for interacting with a hydrogen comprising gas present in said atmosphere for generating hydrogen radicals for removing a deposition from a surface of an optical element of the lithographic apparatus.

31. A device manufacturing method according to claim 30, further comprising:
adding methane to said atmosphere.
